(19) United States
(12) Patent Application Publication
(10) Pub. No.: US 2016/0069762 A1
(43) Pub. Date: Mar. 10, 2016

(54) Electronic Tension Gauge System

(71) Applicant: Hansaloy Corporation, Davenport, IA (US)

(72) Inventors: James Barnes, Le Claire, IA (US); Al McGilvra, Jackson, MI (US)

(21) Appl. No.: 14/479,666

(22) Filed: Sep. 8, 2014

(51) Int. Cl. G01L 5/06

(52) U.S. Cl. CPC G01L 5/06

(57) ABSTRACT

A method of computing a tension value is provided. A strain gauge output signal generated by a strain gauge is received. A strain value is determined from the received strain gauge output signal. A pair of calibration points is identified that bound the strain value. A tension-strain equation is determined from the identified pair of calibration points. A tension value is calculated for the band blade using the determined tension-strain equation and the strain value. The calculated tension value is output.

### BACKGROUND

Slicing assemblies are used in the baking industry to slice various baked goods. The slicing assemblies include one or more band blades for slicing the various baked goods. The band blades are mounted to the slicing assemblies and an optimal amount of tension is applied to the band blades to maximize slicing efficiency and the life of the band blade. Tension measurements may be conducted when changing the distance between band blades (e.g., slice width) and when replacing a band blade.

### SUMMARY

In an example embodiment, a method of computing a tension value is provided. A strain gauge output signal generated by a strain gauge is received. A strain value is determined from the received strain gauge output signal. A pair of calibration points is identified that bound the strain value. A tension-strain equation is determined from the identified pair of calibration points. A tension value is calculated for the band blade using the determined tension-strain equation and the strain value. The calculated tension value is output.

In another example embodiment, a computer-readable medium is provided having stored thereon computer-readable instructions that, when executed by a processor, cause a tension calculator to perform the method of computing a tension value.

In yet another example embodiment, an electronic tension gauge system is provided. The electronic tension gauge system includes, but is not limited to, a tension gauge assembly and a tension calculator. The tension gauge assembly includes, but is not limited to, a housing, a first arm mounted to extend from the housing in a first direction, a beam mounted to extend from the housing in the first direction, and a strain gauge mounted to the beam. The beam is deflectable at a first end in a second direction relative to the housing. The second direction is perpendicular to the first direction. The strain gauge is configured to generate a strain gauge output signal based on the deflection of the beam at the first end when a band blade is positioned between the first arm and the beam. The tension calculator is operably coupled to the strain gauge to receive the strain gauge output signal. The tension calculator includes, but is not limited to, a processor and a computer-readable medium operably coupled to the processor. The computer-readable medium has instructions stored thereon that, when executed by the tension calculator, cause the tension calculator to perform the method of computing a tension value.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of a slicing system in accordance with an illustrative embodiment.

FIG. 2A depicts a side, perspective view of a slicing assembly in accordance with an illustrative embodiment.

FIG. 2B depicts an enlarged view of a portion of the slicing assembly of FIG. 2A.

FIG. 3A depicts a top, perspective view of a tension gauge assembly in accordance with an illustrative embodiment.

FIG. 3B depicts a bottom, perspective view of the tension gauge assembly of FIG. 3A.

FIG. 3C depicts an exploded, perspective view of the tension gauge assembly of FIG. 3A.

FIG. 4 depicts a bottom view of a strain gauge assembly of the tension gauge assembly of FIG. 3A.

FIG. 5A depicts a bottom up, cross-sectional view through the strain gauge assembly of FIG. 4.

FIG. 5B depicts cross-sectional view through the tension gauge assembly of FIG. 3A, including the strain gauge assembly of FIG. 5A.

FIG. 6 depicts a block diagram of an electronic tension gauge system in accordance with an illustrative embodiment.

FIG. 7 is a flow diagram illustrating illustrative operations performed by a tension calculation application in accordance with an illustrative embodiment.

FIG. 8 depicts a front view of a tension calculator in accordance with an illustrative embodiment.

FIG. 9 depicts a side view of the tension calculator of FIG. 8.

FIG. 10 depicts a cross-sectional view of the tension calculator of FIG. 8.

### DETAILED DESCRIPTION

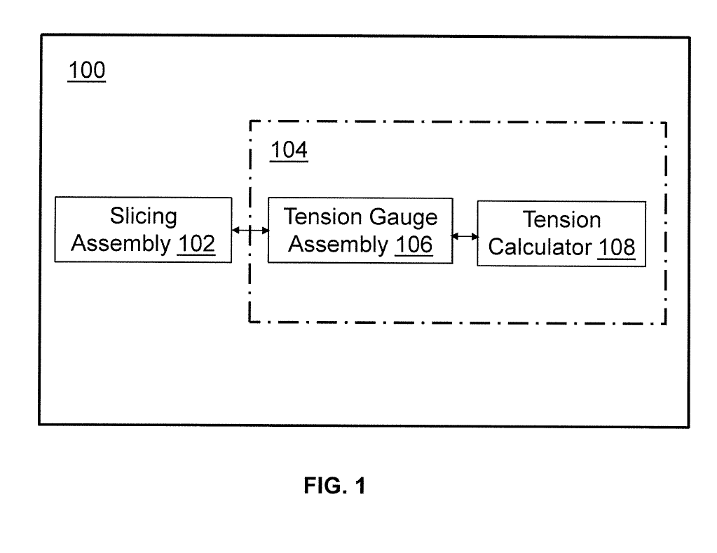

With reference to FIG. 1, a block diagram of a slicing system 100 is shown in accordance with an illustrative embodiment. The slicing system 100 may include a slicing assembly 102 and an electronic tension gauge system 104. The electronic tension gauge system 104 may include a tension gauge assembly 106 and a tension calculator 108. Additional components may be incorporated into the slicing system 100 and the electronic tension gauge system 104.

Slicing system 100 includes any type of slicing assembly 102 which includes one or more band blades mounted on the assembly and which is configured to perform a slicing operation using the band blade(s) to cut, chop, saw, shave, slice, etc. a desired object (e.g., metal, wood, food, meat, bone, baked good, etc.) As used herein, the term “mount” includes join, unite, connect, couple, associate, insert, hang, hold, affix, attach, fasten, bind, paste, secure, bolt, screw, rivet, solder, weld, glue, form over, form in, layer, mold, rest on, rest against, abut, and other like terms. The phrases “mounted on”, “mounted to”, and equivalent phrases indicate any interior or exterior portion of the element referenced. These phrases also encompass direct mounting (in which the referenced elements are in direct contact) and indirect mounting (in which the referenced elements are not in direct contact, but are connected through an intermediate element). Elements referenced as mounted to each other herein may further be integrally formed together, for example, using a molding or thermoforming process as understood by a person of skill in the art. As a result, elements described herein as being mounted to each other need not be discrete structural elements. The elements may be mounted permanently, removably, or releasably unless specified otherwise.

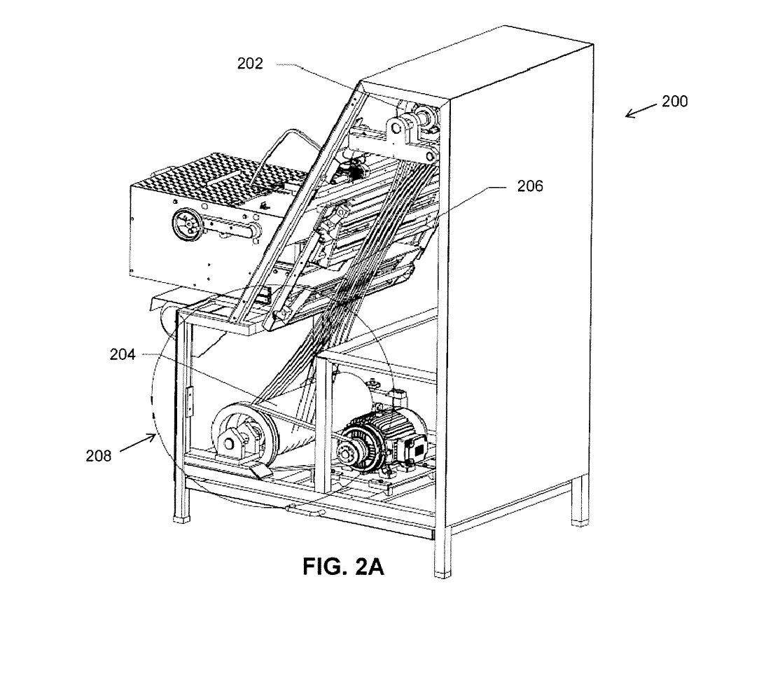

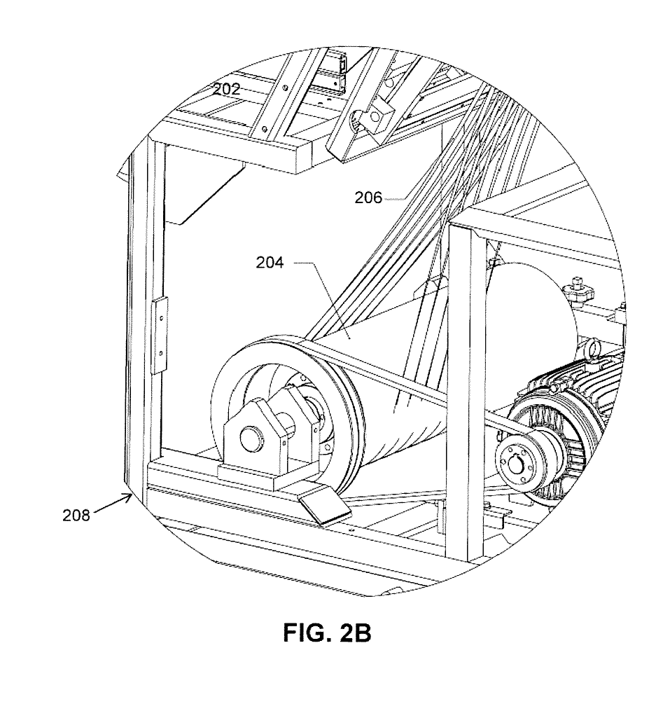

With reference to FIGS. 2A and 2B, a baked goods slicing assembly 200 configured to perform a slicing operation to slice a baked good (e.g., breads, buns, croutons, etc.) is shown in accordance with an illustrative embodiment. The baked goods slicing assembly 200 is an illustrative slicing assembly 102. The baked goods slicing assembly 200 includes two drums, a top drum 202 and a bottom drum 204, suspended from bearings which allow the drums 202, 204 to rotate. Multiple band blades 206 are mounted on the drums 202, 204. A distance between the top drum 202 and the bottom drum 204 may be adjusted to apply a desired tension on the band blades 206. The band blades 206 are mounted such that the band blades 206 cross in the center between the drums 202, 204. This assures that the cutting edge of each band blade 206 can be moved in both directions along the longitudinal axis of the band blade 206 against a baked good passing through the baked goods slicing assembly 200. FIG. 2B shows an enlarged view of the area 208 labeled in FIG. 2A, including the bottom drum 204 and the band blades 206.

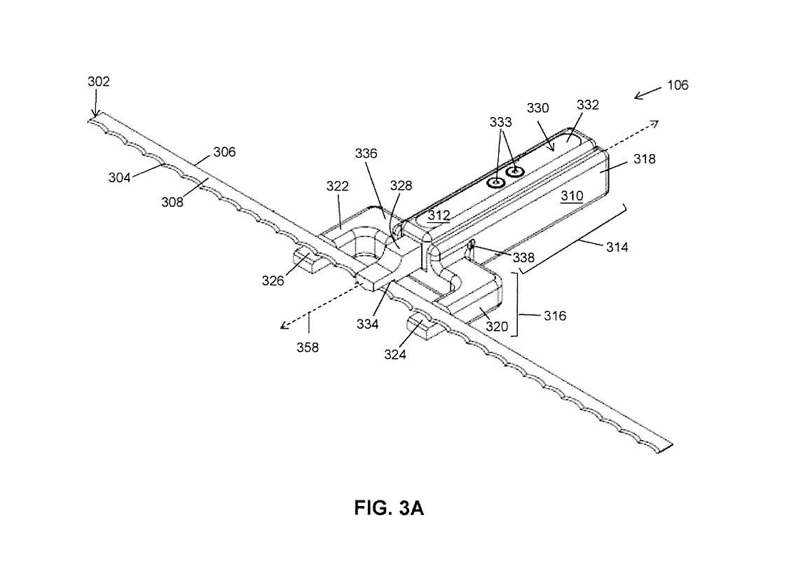

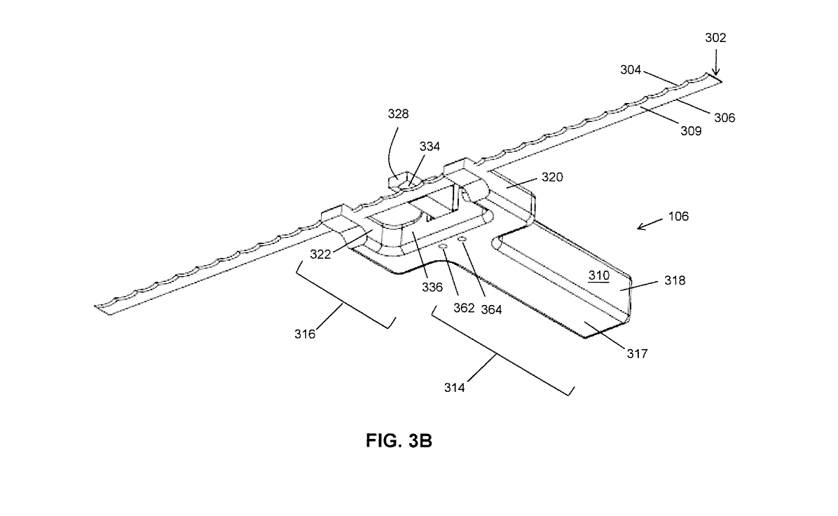

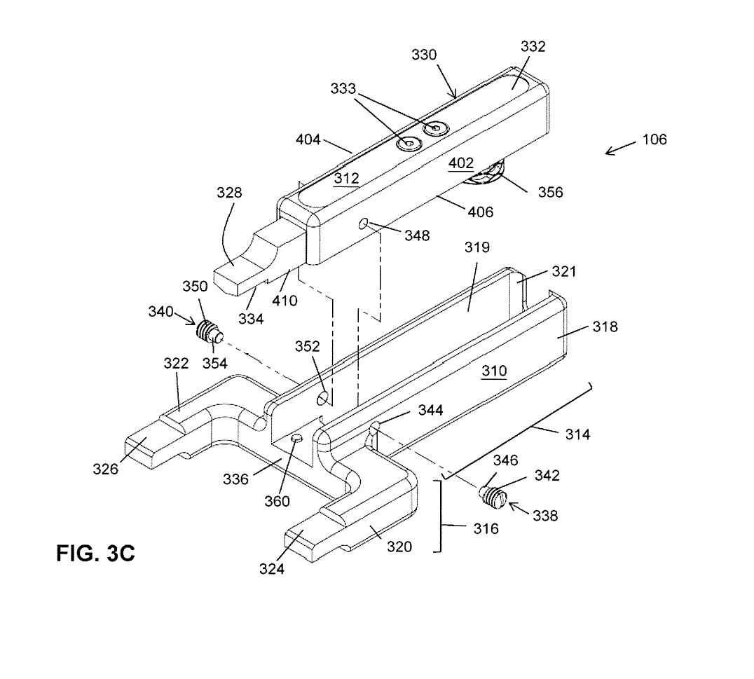

With reference to FIG. 3A, a top perspective view of the tension gauge assembly 106 is shown in accordance with an illustrative embodiment. With reference to FIG. 3B, a bottom perspective view of the tension gauge assembly 106 is shown in accordance with an illustrative embodiment. With reference to FIG. 3C, an exploded view of the tension gauge assembly 106 is shown in accordance with an illustrative embodiment. The tension gauge assembly 106 is shown mounted to a band blade 302 of the band blades 206. The band blade 302 may include a cutting edge 304, a spine edge 306, a top blade surface 308, and a bottom blade surface 309. Use of directional terms, such as top, bottom, right, left, front, back, etc. are merely intended to facilitate reference to various surfaces that form components of the devices referenced herein and are not intended to be limiting in any manner In the illustrative embodiment, band blade 302 is configured to slice bread though other band blades may be used that are configured for use in other slicing operation on other types of objects.

The tension gauge assembly 106 may include a support body 310 and a strain gauge assembly 312 mounted to the support body 310. The support body 310 may include a handle portion 314 and a blade mounting portion 316 mounted to the front end of the handle portion 314. The handle portion 314 may include a base panel 317 and a plurality of walls 318, 319 and 321. The base panel 317 and walls 318, 319 and 321 define a cavity in which the strain gauge assembly 312 is mounted and partially enclosed. The handle portion 314 may be configured in a variety of ways to allow the tension gauge assembly 106 to be readily grasped by a user when attaching the tension gauge assembly 106 to the band blade 302 and detaching the tension gauge assembly 106 from the band blade 302.

The blade mounting portion 316 may be configured in a variety of ways to allow the tension gauge assembly 106 to be mounted to the band blade 302. For example, as shown in the illustrative embodiment, the blade mounting portion 316 may include a first arm 320 and a second arm 322 mounted to opposite sides of a front end of the handle portion 314. First arm 320 and second arm 322 extend substantially parallel to a longitudinal axis of the handle portion 314. The arms 320, 322 may be mounted to the handle portion 314 through a crossbar 336 mounted to the handle portion 314 and oriented perpendicular to the arms 320, 322. Each arm 320, 322 may include a contact area configured to engage with an area on a blade surface of the band blade 302. For example, as shown in the illustrative embodiment, the first arm 320 may include a first contact area 324 formed in a top surface of a front end of the first arm 320 that is configured to engage with a first area on the bottom blade surface 309 as well as a first portion of the spine edge 306. Similarly, the second arm 322 may include a second contact area 326 formed in a top surface of a front end of the second arm 322 that is configured to engage with a second area on the bottom blade surface 309 as well as a second portion of the spine edge 306. The support body 310 is sized and shaped to allow the tension gauge assembly 106 to fit within a desired slicing assembly.

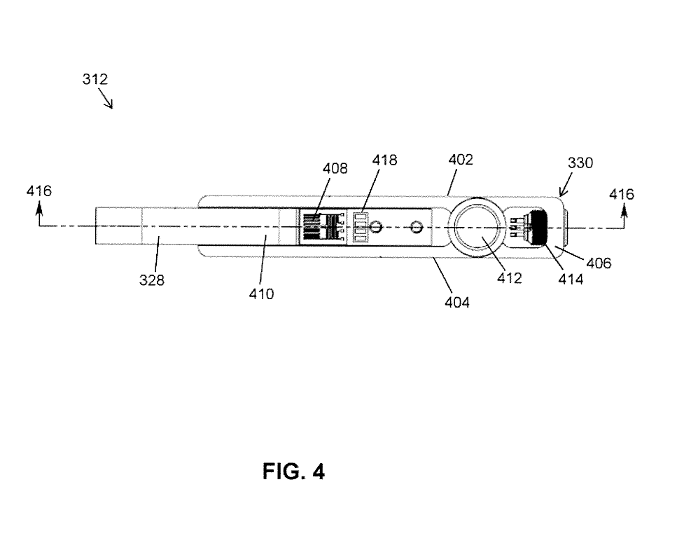

The strain gauge assembly 312 may include a beam 328 and a beam housing 330 mounted to the beam 328. The beam housing 330 may include a ceiling panel 332, a right side wall 402, a left side wall 404 (with reference to FIG. 4), and a bottom wall 406 that extends between the right side wall 402 and the left side wall 404. The ceiling panel 332, the right side wall 402, the left side wall 404, and the bottom wall 406 define a cavity in which the beam 328 is mounted and partially enclosed. The beam housing 330 may be mounted to the beam via one or more fasteners 333 (e.g., screws or the like).

As shown in the illustrative embodiment, the strain gauge assembly 312 may be mounted to the support body 310 such that the beam 328 is positioned between the first arm 320 and the second arm 322 and extends substantially parallel to the arms 320, 322. The strain gauge assembly 312 may be pivotably mounted to the support body 310 via a first pivot point fastener 338 and a second pivot point fastener 340 to allow the strain gauge assembly 312 to pivot within the handle portion 314 of the support body 310 about the first pivot point fastener 338 and the second pivot point fastener 340. The first pivot point fastener 338 may include a first threaded end 342 that mounts to a first threaded hole 344 defined in the wall 318 of the handle portion 314. The first pivot point fastener 338 may further include a first rod end 346 that is inserted in a first hole 348 defined in the right side wall 402 of the beam housing 330. Similarly, the second pivot point fastener 340 may include a second threaded end 350 that mounts to a second threaded hole 352 in the wall 319 of the handle portion 314. The second pivot point fastener 340 may further include a second rod end 354 that engages with a second hole (not shown) defined in the left side wall 404 of the beam housing 330. A first travel stop 360 and a second travel stop (not shown) may be mounted to the base panel 317 of the handle portion 314 via a first hole 362 and a second hole 364 defined in the base panel 317. The travel stops may be positioned and configured to limit the amount of bending of the beam 328 in the strain gauge assembly 312 towards the base panel 317. The upward extent of the first travel stop 360 and the second travel stop may be adjustable by insertion of an adjustment tool (e.g. screw driver) into the first hole 362 and the second hole 364.

The beam 328 may also include a contact area 334 formed in a bottom surface 410 of a front end of the beam 328. Contact area 334 is configured to engage with an area on the top blade surface 308 as well as a third portion of the spine edge 306. As a result, the band blade 302 is positioned longitudinally between the first arm 320, the second arm 322, and the beam 328.

With reference to FIG. 3C, a spring 356 may be mounted between the strain gauge assembly 312 and the support body 310.

With reference to FIG. 4, a bottom view of the strain gauge assembly 312 of FIG. 3A is shown. The strain gauge assembly 312 may include a strain gauge 408 mounted to the bottom surface 410 of the beam 328. A bottom of a spring mounting surface 412 may be mounted to the bottom surface of the beam housing 330 near a back end of the strain gauge assembly 312. A connector plug 414 may be mounted to the beam housing 330 and configured to operably couple the strain gauge 408 to the tension calculator 108 shown in FIG. 1. For example, ribbon leads from the strain gauge 408 may be soldered to a transition pad 418 mounted to the bottom surface 410 of the beam 328. A four conductor flat wire cable (not shown) may be soldered to pins in the connector plug 414.

The strain gauge 408 may be any device configured to measure strain in an object on which the strain gauge 408 is mounted by converting the mechanical deformation induced by an applied force on the object into an electronic signal, i.e., a strain gauge output signal. A variety of types of strain gauges may be used, e.g., a full Wheatstone bridge strain gauge such as those sold by Omega Engineering Inc. in Stamford, Conn. The tension gauge assembly 106 is further configured to generate the strain gauge output signal from the strain gauge 408 when the tension gauge assembly 106 is mounted to the band blade 302 under tension. The strain gauge output signal is proportional to a magnitude of the tension applied to the band blade 302.

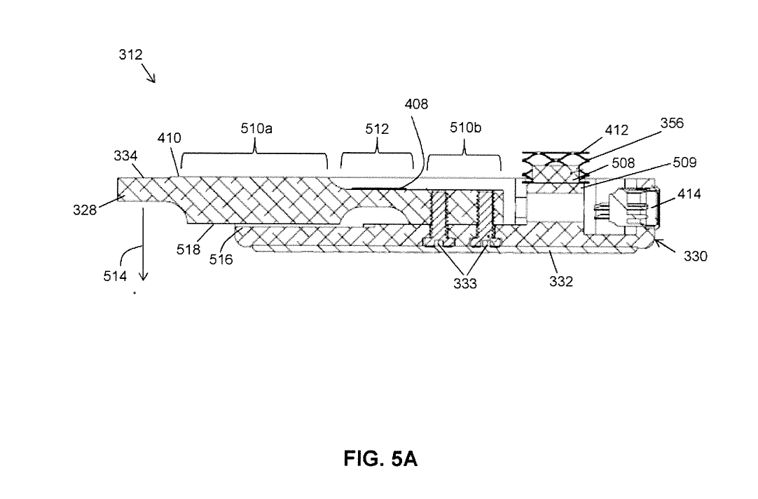

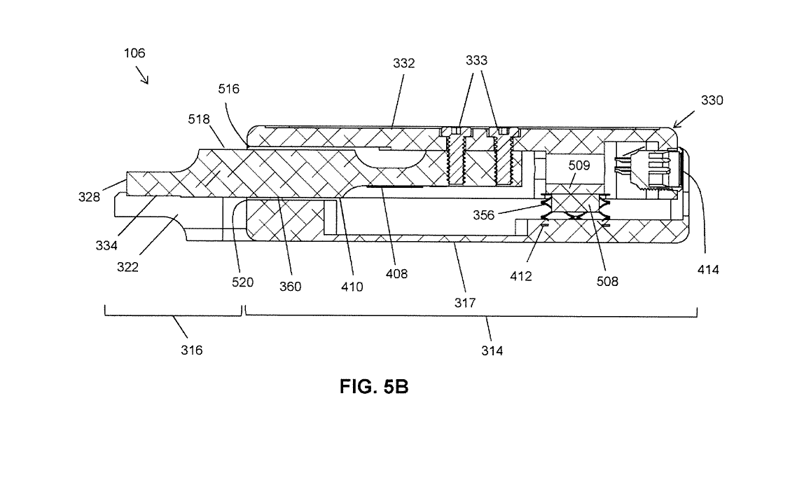

With reference to FIG. 5A, a cross-sectional view of the strain gauge assembly 312 of FIG. 4 taken along axis 416 is shown. The ceiling panel 332 of the beam housing 330 is shown, mounted to the beam 328 via the fasteners 333 near the back end of the beam 328. Thus, the beam 328 is configured as a cantilever. The strain gauge 408 is mounted to the bottom surface 410 of the beam 328. The contact area 334 is formed in the bottom surface 410 of the front end of the beam 328. The spring 356 is shown mounted between the spring mounting surface 412 and a stop block 509. A third travel stop 508 extends from the stop block 509 towards the spring mounting surface 412. The spring 356 extends around the travel stop 508. The third travel stop 508 limits the displacement of the strain gauge assembly 312 within the handle portion 314 by contacting the spring mounting surface 412. The compression force of the spring 356 exerts a predetermined force against the back end of the beam 328 and acts as a known counterbalance to a force exerted against the contact area 334. The predetermined force may be that which is sufficient to hold the tension gauge assembly 106 against the band blade 302. The predetermined force may be associated with a minimum tension value of the band blade 302.

In the illustrative embodiment, a thickness of the beam 328 may not be uniform along its longitudinal length and may include a relatively thin portion 512 between a first thick portion 510a and a second thick portion 510b. The strain gauge 408 may be mounted to the relatively thin portion 512. Such a configuration allows the beam 328 to deform (flex) more easily when a force is applied to the contact area 334 at the front end of the beam 328. The specific dimensions and materials used for the beam 328 may depend upon the type of strain gauge selected because strain gauges are generally matched to the modulus of elasticity and yield strength of the material of the object (i.e., the beam 328) to which they are mounted and because the strain gauge output signal depends upon this material and the cross-sectional area of the object. The beam 328 may be formed of aluminum, stainless steel, etc.

When using the tension gauge assembly 106, the spring 356 applies the predetermined force on the strain gauge assembly 312. The specific dimensions and material used for the spring 506 may depend upon the predetermined force. When the tension gauge assembly 106 is mounted to the band blade 302, the spring 356 applies a deflection force against the force applied to the contact area 334 by the top surface 308 of the band blade 302. The force applied to the contact area 334 by the top surface 308 of the band blade 302 is proportional to the amount of tension on the band blade 302. The force applied to the contact area 334 by the top surface 308 of the band blade 302 bends the beam 328 in a z⁺ direction indicated by a first arrow 514, thereby generating a strain gauge output signal from the strain gauge 408. The amount of force applied to the contact area 334 by the top surface 308 of the band blade 302 is proportional to the amount of tension on the band blade 302. The force applied to the contact area 334 by the top surface 308 of the band blade 302 deforms the beam 328 relative to an initial position in which no force is applied to the contact area 334 and only the spring 356 is providing a force to the beam 328.

As shown in the illustrative embodiment of FIG. 5A, a gap may be formed between a bottom surface 516 of the ceiling panel 332 of the beam housing 330 and a top surface 518 of the beam 328. The gap allows the beam 328 to float freely at an end of the beam 328 that forms the contact area 334 and may be configured to accommodate the bending of the beam 328 in the z⁺ direction relative to the back end of the beam 328 that includes the fasteners 333.

With reference to FIG. 5B, a cross-sectional view of the tension gauge assembly 106 is shown, taken along axis 358 (with reference to FIG. 3A). The base panel 317 of the handle portion 314 is shown along with the second arm 322 of the blade mounting portion 316. The spring mounting surface 412 is shown mounted to the base panel 317 of the handle portion 314. The spring 356 is shown extending around the third travel stop 508 and mounted between the spring mounting surface 412 and the stop block 509. A second gap opposite the gap may be formed between a top surface 520 of the base panel 317 and the bottom surface 410 of the beam 328. First travel stop 360 is positioned in the second gap between the top surface 520 of the base panel 317 and the bottom surface 410 of the beam 328.

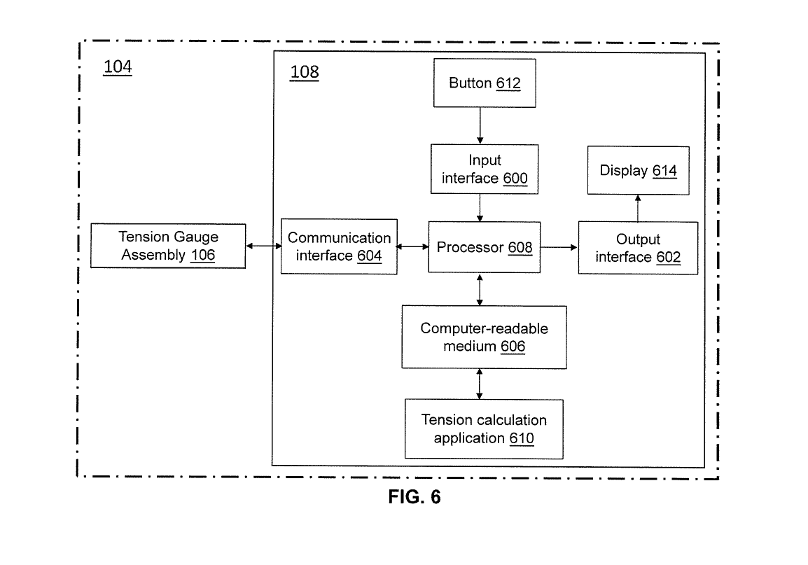

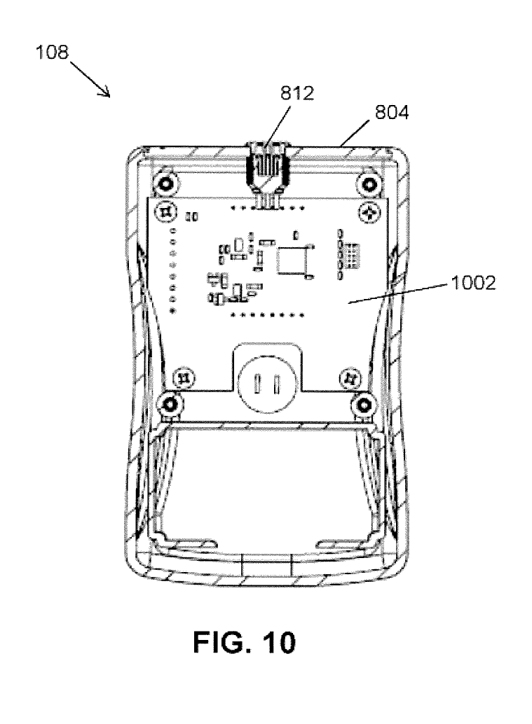

With reference to FIG. 6, the tension calculator 108 of the electronic tension gauge system 104 is shown in accordance with an illustrative embodiment. The tension calculator 108 is configured to calculate a tension value for the band blade 302 from the strain gauge output signal received from the tension gauge assembly 106. The tension calculator 108 may include an input interface 600, an output interface 602, a communication interface 604, a computer-readable medium 606, a processor 608, a tension calculation application 610, a button 612, and a display 614. Different, fewer, and additional components may be incorporated into the tension calculator 108. With reference to FIG. 10, some or all of the components of the tension calculator 108 may be mounted on a printed circuit board 1002.

Input interface 600 provides an interface for receiving information from a user for processing by tension calculator 108 as known to those skilled in the art. Input interface 600 may interface with various input technologies including, but not limited to, a button 612, a keyboard, a mouse, a touch screen, a track ball, a keypad, etc. to allow the user to enter information into tension calculator 108 or to make selections presented in a user interface displayed on display 614. Tension calculator 108 may have one or more input interfaces that use the same or different input interface technology.

Output interface 602 provides an interface for outputting information for review by a user of tension calculator 108. For example, output interface 602 may interface with various output technologies including, but not limited to, display 614, a speaker, a printer, etc. Tension calculator 108 may have one or more output interfaces that use the same or a different output interface technology.

Communication interface 604 provides an interface for receiving and transmitting data between devices using various protocols, transmission technologies, and media as known to those skilled in the art. The communication interface may support communication using various transmission media that may be wired and/or wireless. Tension calculator 108 may have one or more communication interfaces that use the same or different communication interface technology. In the illustrative embodiment of FIG. 6, the communication interface 604 provides an interface for receiving the strain gauge output signal from the strain gauge 408 mounted to the tension gauge assembly 106.

Computer-readable medium 606 is an electronic holding place or storage for information so the information can be accessed by processor 608 as understood by those skilled in the art. Computer-readable medium 606 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. Tension calculator 108 may have one or more computer-readable media that use the same or a different memory media technology. For example, computer-readable medium 606 may include different types of computer-readable media that may be organized hierarchically to provide efficient access to the data stored therein as understood by a person of skill in the art. As an example, a cache may be implemented in a smaller, faster memory that stores copies of data from the most frequently/recently accessed main memory locations. Tension calculator 108 also may have one or more drives that support the loading of a memory media such as a CD, DVD, an external hard drive, etc. One or more external hard drives further may be connected to tension calculator 108 using communication interface 604.

Processor 608 executes instructions as understood by those skilled in the art. The instructions may be carried out by a special purpose computer, logic circuits, or hardware circuits. Processor 608 may be implemented in hardware and/or firmware. Processor 608 executes an instruction, meaning it performs/controls the operations called for by that instruction. The term “execution” is the process of running an application or the carrying out of the operation called for by an instruction. The instructions may be written using one or more programming language, scripting language, assembly language, etc. Processor 608 operably couples with input interface 600, with output interface 602, with communication interface 604, and with computer-readable medium 606 to receive, to send, and to process information. Processor 608 may retrieve a set of instructions from a permanent memory device and copy the instructions in an executable faun to a temporary memory device that is generally some form of RAM. Tension calculator 108 may include a plurality of processors that use the same or a different processing technology.

Tension calculation application 610 performs operations associated with processing the strain gauge output signal generated by the tension gauge assembly 106 to calculate the tension value on the band blade 302. Some or all of the operations described herein may be controlled by instructions embodied in tension calculation application 610. The operations may be implemented using hardware, firmware, software, or any combination of these methods. With reference to the example embodiment of FIG. 6, tension calculation application 610 is implemented in software (comprised of computer-readable and/or computer-executable instructions) stored in computer-readable medium 606 and accessible by processor 608 for execution of the instructions that embody the operations of tension calculation application 610. Tension calculation application 610 may be written using one or more programming languages, assembly languages, scripting languages, etc.

The tension gauge assembly 106 and the tension calculator 108 may be integrated into a single device, e.g., the tension calculator 108 may be implemented as a component of the tension gauge assembly 106. Alternatively, the tension gauge assembly 106 and the tension calculator 108 may be implemented in separate devices and may be connected using communication interface 604.

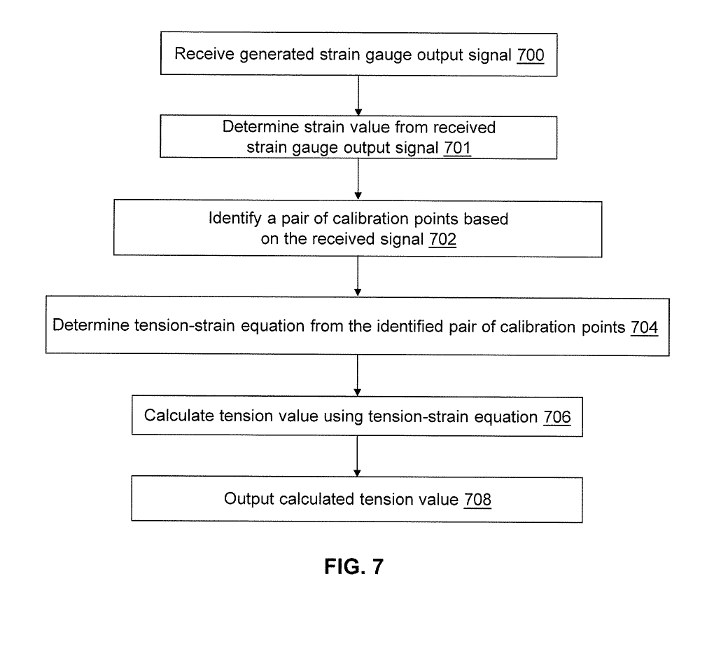

With reference to FIG. 7, illustrative operations associated with tension calculation application 610 are described according to an illustrative embodiment. Additional and different operations may be performed. The order of the operations is not intended to be limiting. In an operation 700, the strain gauge output signal generated by the tension gauge assembly 106 is received by the tension calculator 108, for example, through the connector plug 414 mounted to communication interface 604.

In an operation 701, a strain value is determined from the strain gauge output signal. The determined strain value indicates an amount of deflection of the beam at the first end when a band blade is positioned between the first arm 320 and/or the second arm 322 and the beam 328. As an example, the strain gauge output signal may be a value of a voltage that is converted to the strain value by a scale that defines the relationship between the voltage and the strain.

In an operation 702, a pair of calibration points is identified based on the received strain gauge output signal from a set of calibration points. A first calibration point in the pair may be characterized by a first strain value x₁ and a first tension value y₁, and a second calibration point in the pair may be characterized by a second strain value x₂ and a second tension value y₂. The pair of calibration points may be identified by comparing the strain value from the received strain gauge output signal to the strain values in the set of calibration points and determining which two strain values x₁ and x₂, and thus, which two calibration points x₁, y₁ and x₂, y₂, the strain gauge output signal falls between. The two strain values x₁ and x₂ of the identified pair of calibration points bound the strain value.

In an illustrative embodiment, the set of predetermined calibration points are determined for a minimum tension setting for the band blade, a maximum tension setting for the band blade, and a middle value of an optimum tension range for the band blade. For example, the minimum tension setting for the band blade may be at 40 pounds with an associated strain value read from the strain gauge 408 to define a first calibration point in the set of predetermined calibration points. The middle value of an optimum tension range of 65 to 75 pounds for the band blade may be set at 75 pounds with an associated strain value read from the strain gauge 408 to define a second calibration point in the set of predetermined calibration points. The maximum tension setting for the band blade may be at 110 pounds with an associated strain value read from the strain gauge 408 to define a third calibration point in the set of predetermined calibration points. A fewer or a greater number of calibration points may be used, for example, to provide a more accurate tension value.

In an operation 704, a tension-strain equation is determined from the identified pair of calibration points, x₁, y₁ and x₂, y₂. The tension-strain equation may be determined by calculating a slope m using m=(y₁−y₂)/(x₁−x₂) and an intercept b using b=y₁−mx₁.

In an operation 706, a tension value for the band blade mounted to the tension gauge assembly 106 is calculated using the determined tension-strain equation y=mx+b determined in operation 704, where y is the tension value, m is the slope determined in operation 704, x is the determined strain value, and b is the intercept from operation 704.

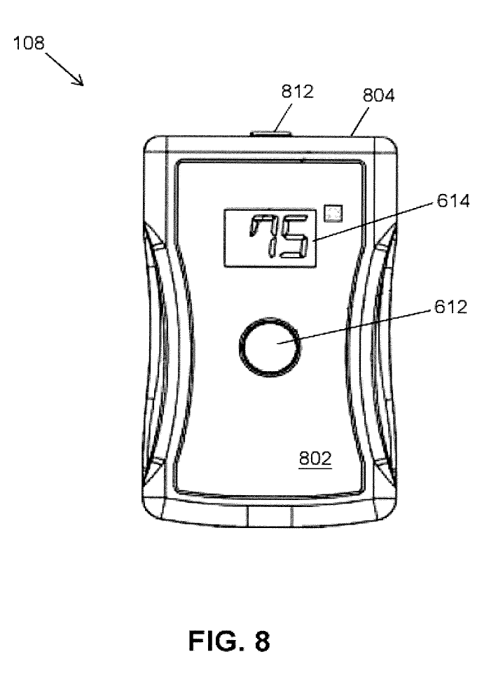

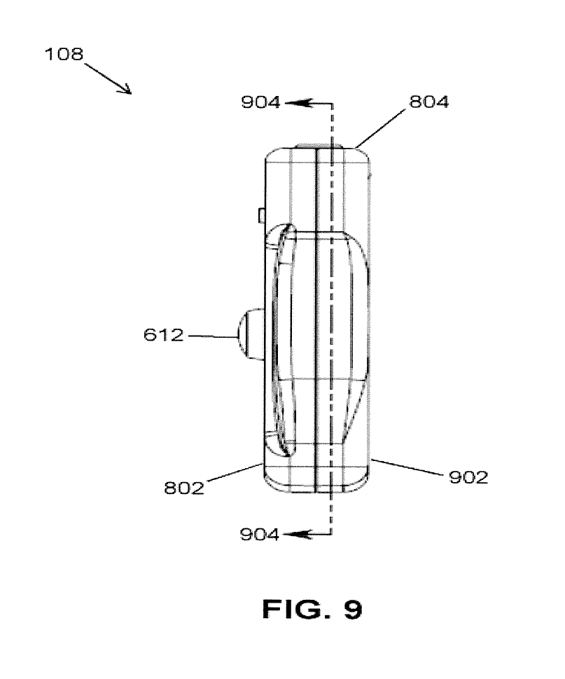

With reference to FIGS. 8-10, the tension calculator 108 is shown in accordance with an illustrative embodiment. The tension calculator 108 may be sized and shaped to fit easily within a hand of a user. FIG. 8 shows a front view of the tension calculator 108. FIG. 9 shows a side view of the tension calculator 108. FIG. 10 shows a cross-sectional view of the tension calculator 108 taken along an axis 904 shown in FIG. 9. In the illustrative embodiment of FIGS. 8-10, the tension calculator 108 is implemented as a separate device from the tension gauge assembly 106. The tension calculator 108 may include a front panel 802 mounted to a back panel 902. The printed circuit board 1002 is mounted between the front panel 802 and the back panel 902.

Display 614 and button 612 are mounted to the front panel 802. A second connector plug 812 is mounted to a top wall 804 of the tension calculator 108. The second connector plug 812 is configured to operably couple to the connector plug 414 of the tension gauge assembly 106 to receive the strain gauge output signal.

In the illustrative embodiment, the electronic tension gauge system 104 may be used to repeatedly and reliably calculate tension values in the range from about 40 pounds to about 199 pounds for band blades characterized by a thickness in the range of from about 0.0160 inches to about 0.018 inches. The components of the electronic tension gauge system may be modified to calculate tension values outside this tension value range from band blades having thicknesses outside this thickness range.

Components of the system electronic tension gauge system 104 may be made from any type of material having sufficient strength, rigidity, and/or flexibility for the described application.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” in the detailed description is intended to include “and/or” unless specifically indicated otherwise.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A computer-readable medium having stored thereon computer-readable instructions that when executed by a processor cause a tension calculator to:
determine a strain value from a received strain gauge output signal, wherein the strain gauge output signal is generated by a strain gauge;
identify a pair of calibration points that bound the strain value;
determine a tension-strain equation from the identified pair of calibration points;
calculate a tension value for the band blade using the determined tension-strain equation and the strain value; and
output the calculated tension value.

2. The computer-readable medium of claim 1, wherein the pair of calibration points is identified from a set of predetermined calibration points, wherein the set of predetermined calibration points are determined for a minimum tension setting for the band blade, a maximum tension setting for the band blade, and a middle value of an optimum tension range for the band blade.

3. The computer-readable medium of claim 1, wherein (x₁, y₁) is a first calibration point of the pair of calibration points, (x₂, y₂) is a second calibration point of the pair of calibration points, wherein x₁ is a first strain value, x₂ is a second strain value, y₁ is a first tension value that results when the first strain value is generated by the strain gauge, and y₂ is a second tension value that results when the second strain value is generated by the strain gauge.

4. The computer-readable medium of claim 3, wherein x₁≦x≦x₂, x is the determined strain value.

5. The computer-readable medium of claim 4, wherein the tension-strain equation is y=mx+b, wherein y is the calculated tension value, m is determined from m=(y₁−y₂)/(x₁−x₂) and b is determined from b=y₁−mx₁.

6. The computer-readable medium of claim 1, wherein the calculated tension value is output to a display.

7. A method of computing a tension value, the method comprising:
receiving a strain gauge output signal generated by a strain gauge;
determining, by a processor, a strain value from the received strain gauge output signal;
identifying, by the processor, a pair of calibration points that bound the strain value;
determining, by the processor, a tension-strain equation from the identified pair of calibration points;
calculating, by the processor, a tension value for the band blade using the determined tension-strain equation and the strain value; and
outputting, by the processor, the calculated tension value.

8. The method of claim 7, wherein the pair of calibration points is identified from a set of predetermined calibration points, wherein the set of predetermined calibration points are determined for a minimum tension setting for the band blade, a maximum tension setting for the band blade, and a middle value of an optimum tension range for the band blade.

9. The method of claim 7, wherein (x₁, y₁) is a first calibration point of the pair of calibration points, (x₂, y₂) is a second calibration point of the pair of calibration points, wherein xi is a first strain value, x₂ is a second strain value, y₁ is a first tension value that results when the first strain value is generated by the strain gauge, and y₂ is a second tension value that results when the second strain value is generated by the strain gauge.

10. The method of claim 9, wherein x₁≦x≦x₂, x is the determined strain value.

11. The method of claim 10, wherein the tension-strain equation is y=mx+b, wherein y is the calculated tension value, m is determined from m=(y₁−y₂)/(x₁−x₂) and b is determined from b=y₁−mx₁.

12. An electronic tension gauge system comprising:
a tension gauge assembly comprising
a housing;
a first arm mounted to extend from the housing in a first direction;
a beam mounted to extend from the housing in the first direction, wherein the beam is deflectable at a first end in a second direction relative to the housing, wherein the second direction is perpendicular to the first direction; and
a strain gauge mounted to the beam, the strain gauge configured to generate a strain gauge output signal based on the deflection of the beam at the first end when a band blade is positioned between the first arm and the beam; and
a tension calculator operably coupled to the strain gauge to receive the strain gauge output signal, the tension calculator comprising
a processor; and
a non-transitory computer-readable medium operably coupled to the processor, the computer-readable medium comprising instructions that, when executed by the processor, cause the tension calculator to
determine a strain value from the received strain gauge output signal;
identify a pair of calibration points that bound the strain value;
determine a tension-strain equation from the identified pair of calibration points;
calculate a tension value for the band blade using the determined tension-strain equation and the strain value; and
output the calculated tension value.

13. The electronic tension gauge system of claim 12, wherein the pair of calibration points is identified from a set of predetermined calibration points, wherein the set of predetermined calibration points are determined for a minimum tension setting for the band blade, a maximum tension setting for the band blade, and a middle value of an optimum tension range for the band blade.

14. The electronic tension gauge system of claim 12, wherein (x₁, y₁) is a first calibration point of the pair of calibration points, (x₂, y₂) is a second calibration point of the pair of calibration points, wherein x₁ is a first strain value, x₂ is a second strain value, y₁ is a first tension value that results when the first strain value is generated by the strain gauge, and y₂ is a second tension value that results when the second strain value is generated by the strain gauge.

15. The electronic tension gauge system of claim 14, wherein x₁≦x≦x₂, x is the determined strain value.

16. The electronic tension gauge system of claim 15, wherein the tension-strain equation is y=mx+b, wherein y is the calculated tension value, m is determined from m=(y₁−y₂)/(x₁−x₂) and b is determined from b=y₁−mx₁.

17. The electronic tension gauge system of claim 12, further comprising a display, wherein the calculated tension value is output to the display.

18. The electronic tension gauge system of claim 12, wherein the tension gauge assembly further comprises a second arm mounted to extend from the housing in the first direction, wherein the strain gauge output signal is generated when the band blade is positioned between the second arm and the beam.

19. The electronic tension gauge system of claim 12, wherein the tension gauge assembly further comprises a beam housing mounted to the housing, wherein the beam is mounted to the beam housing.

20. The electronic tension gauge system of claim 19, further comprising a spring mounted between the beam housing and the housing adjacent a second end of the beam that is opposite the first end of the beam, wherein the spring is configured to apply a predetermined force to the second end of the beam.
